(19) United States
(12) Patent Application Publication
(10) Pub. No.: US 2006/0085564 A1
(43) Pub. Date: Apr. 20, 2006

(54) Flash mirroring

(76) Inventors: Matthew D. Bomhoff, Tucson, AZ (US); Brian J. Cagno, Tucson, AZ (US); Gregg S. Lucas, Tucson, AZ (US); Kenny N. Qiu, Tucson, AZ (US); Andrew E. Seidel, Tucson, AZ (US)

Correspondence Address: QUARLES & BRADY STREICH LANG LLP, 1 SOUTH CHURCH AVENUE, SUITE 1700, TUCSON, AZ, 85701, US

(21) Appl. No.: 10/965,378

(22) Filed: Oct. 14, 2004

(51) Int. Cl. G06F 3/00

(52) U.S. Cl. 710/8

(57) ABSTRACT

A firmware update system includes a high-level management device implementing high-level management software application that selects a redundant embedded processor as a master sub-system. Firmware update images are transmitted to the master sub-system over a primary communication path. The master sub-system re-distributes the firmware update images to other associated redundant embedded processors over secondary communication paths. This reduces communication-bandwidth utilization over direct communication paths between the high-level management system and the other associated redundant embedded processors.

### BACKGROUND OF THE INVENTION

1. Field of the Invention

This invention is related in general to embedded systems. In particular, the invention consists of a method for updating firmware within multiple embedded processors utilizing a single update procedure.

2. Description of the Prior Art

A large number of present-day devices, such as automation systems, data-storage systems, toys, appliances, and automobiles, utilize embedded systems to control their functionality. These embedded systems include processing devices (“processors”) for processing information and issuing commands to other device components. These processors require operating instructions to control their operation. Additionally, these processors have internal memory locations and buffers for holding and manipulating data. The combination of operating instructions and data used by an embedded processor is referred to as firmware and the logical construct that defines the processor is referred to as the firmware image.

In complex systems, a high-level management device implements high-level management software to direct and control low-level embedded processors located within sub-systems. One function of the high-level management software is to program these embedded processors with updated firmware images in order to change the functionality of the processors. This is accomplished by downloading a new firmware image into a download buffer which may either be part of or external to the embedded processor. Once fully downloaded, the new firmware image is loaded into the processor, replacing the original firmware image.

In order to provide increased fault-tolerance, embedded systems sometimes utilize redundant processors. Each redundant processor is usually connected to and controlled by the high-level management device through a direct communication path. If new firmware images need to be loaded into the processors, these images are traditionally transmitted to each redundant processor through the direct communication path,

Updating firmware for redundant processors is a communication-bandwidth intensive task as it involves transferring large amounts of data. While firmware updates are being transmitted, the direct communication path may not be used for other purposes. Accordingly, it would be advantageous to have a system for updating redundant embedded processors that minimizes the communication bandwidth utilization of the direct communication path.

### SUMMARY OF THE INVENTION

The invention disclosed herein utilizes secondary communication paths between redundant embedded processors to reduce communication bandwidth utilization of a primary communication path during firmware updates. A high-level management device implements high-level management software to select one of the redundant embedded processors as a master sub-system and instructs it to prepare for a firmware download. The high-level management software also instructs the master sub-system to establish a secondary communication path to all other associated redundant processors and to direct them to prepare for firmware downloads of their own. The high-level management device then transmits an updated firmware image to the master sub-system where it is re-distributed to the other associated redundant processors over the secondary communication paths.

Various other purposes and advantages of the invention will become clear from its description in the specification that follows and from the novel features particularly pointed out in the appended claims. Therefore, to the accomplishment of the objectives described above, this invention comprises the features hereinafter illustrated in the drawings, fully described in the detailed description of the preferred embodiments and particularly pointed out in the claims. However, such drawings and description disclose just a few of the various ways in which the invention may be practiced.

### BRIEF DESCRIPTION OF THE DRAWINGS

FIG. 1 is a block diagram illustrating a firmware-image update system including a high-level management device, redundant embedded processors, direct communication paths between the high-level management device and the redundant embedded processors, and secondary communication paths between the redundant embedded processors.

FIG. 2 is a block diagram of the firmware-image update system of FIG. 1, wherein the high-level management device has selected a master sub-system and a primary communication path.

FIG. 3 is a flow chart illustrating the process of updating firmware images in redundant embedded processors according to the invention.

### DESCRIPTION OF THE PREFERRED EMBODIMENTS

This invention is based on the idea of utilizing secondary communication paths between redundant embedded processors to reduce bandwidth utilization of direct communication paths between the redundant embedded processors and a high-level management device. The invention disclosed herein may be implemented as a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (“FPGAs”), application-specific integrated circuits (“ASICs”), complex programmable logic devices (“CPLDs”), programmable logic arrays (“PLAs”), microprocessors, or other similar processing devices.

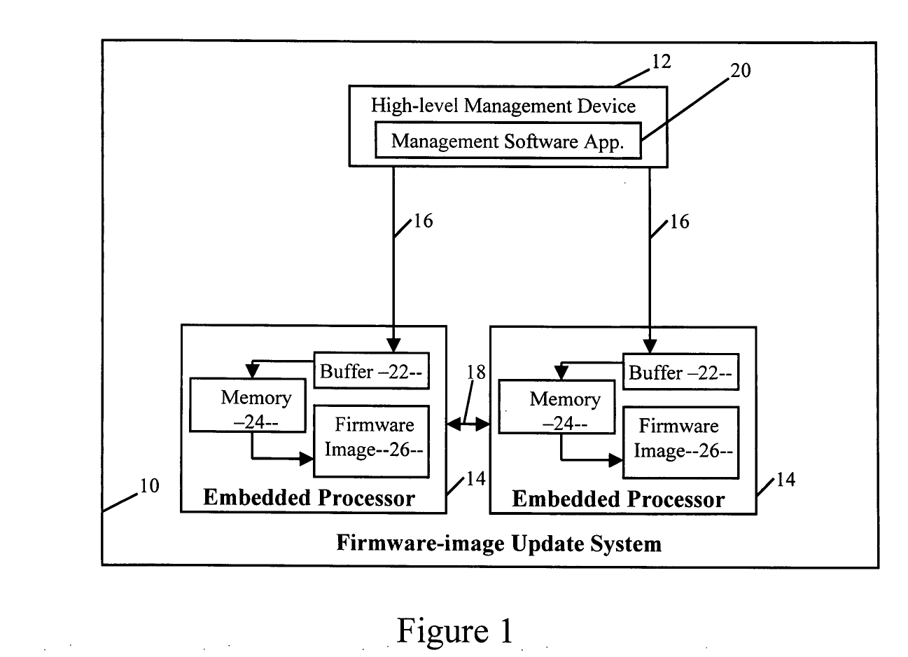

Referring to figures, wherein like parts are designated with the same reference numerals and symbols, FIG. 1 is a block diagram of a firmware-image update system 10 including a high-level management device 12, redundant embedded processors 14, direct communication paths 16 between the high-level management device 12 and the redundant embedded processors 14, and secondary communication paths 18 between the redundant embedded processors 14. The high-level management device 12 may be a general-purpose computer, computer processor, or other computing device tasked with managing and controlling the activity of the redundant embedded processors 14. In this embodiment of the invention, the algorithm for controlling the redundant embedded processors 14 is embodied within a high-level management software application 20.

The redundant embedded processors may be micro-processors, general-purpose computing devices, or programmable logic devices. In this embodiment of the invention, the redundant embedded processors 14 are computer processors each with a download buffer 22, a non-volatile memory 24 for holding firmware images, and a logical construct 26 implementing a firmware image.

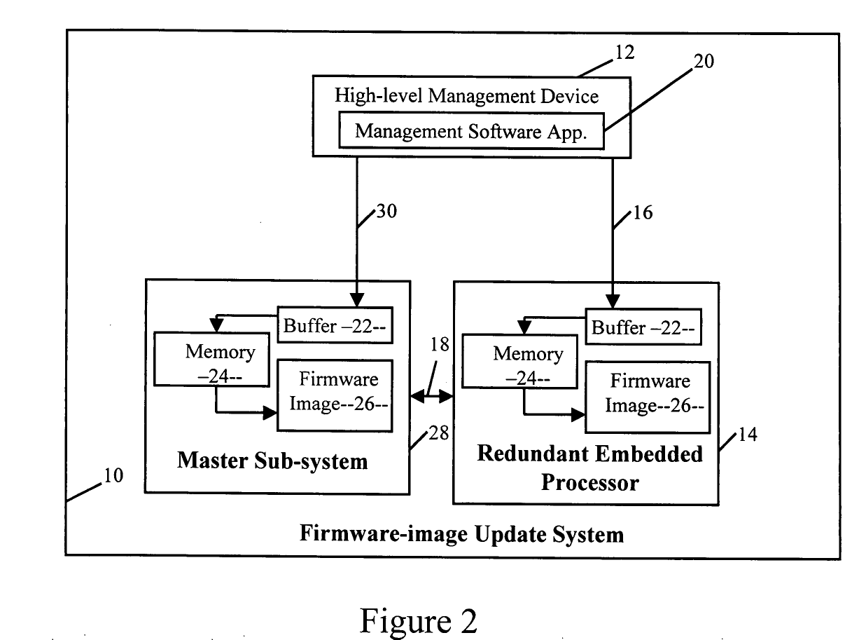

In FIG. 2, the high-level management software application 20 has selected one of the redundant embedded processors 14 as a master sub-system 28. In the process, the direct communication path between the high-level management device 12 and the master sub-system 28 is implicated as a primary communication path 30. The master sub-system 28 is adapted to transmit data and control instructions over the secondary communication paths to the other associated redundant embedded processors 14.

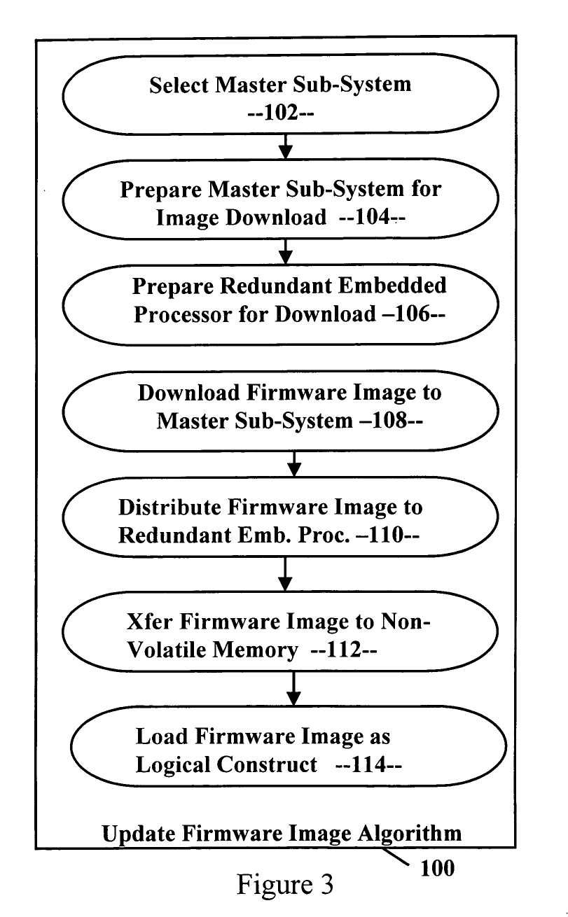

The flow chart of FIG. 3 illustrates the process of updating firmware in the redundant embedded processors 14 using an update firmware images algorithm 100. In step 102, the high-level management device 12 selects a redundant embedded processor 14 as a master sub-system 28. The high-level management device 12 instructs the master sub-system 28 to prepare for a firmware update in step 104. Upon receiving this command, the master sub-system 28 initializes the download buffer 22 and erases the non-volatile memory 24. In step 106, the master sub-system 28 transmits a control command to the other associated redundant embedded processors 14 instructing them to prepare for a firmware update.

Once the master sub-system 28 and other associated redundant embedded processors 14 are properly prepared, the high-level management device begins streaming a new firmware image to the master sub-system (step 108), where it is accumulated in the download buffer 22 or it can be transferred to nonvolatile memory 24 if the download buffer size is limited. The transmission of the firmware image data can be broken down into many small pieces to avoid reducing the bandwidth of important tasks through the primary path 16. In addition, during the process of transmitting the firmware image data, any of the redundant sub-systems can be selected to be the master sub-system and the primary path 16 can be changed depending on which master sub-system is selected. It should be noted that the firmware update process is accomplished concurrent with normal system operation. In step 110, the master sub-system re-distributes the new firmware image to the other associated redundant embedded processors 14 through the secondary communication paths 18. This re-distribution may occur as information arrives in the download buffer 22 of the master sub-system 28, or may be distributed once the firmware download is complete. Once the new firmware image has been received by all the redundant embedded processors, it is transferred to each associated non-volatile memory 24 (step 112). Optionally, the new firmware image may be validated by calculating the checksum or CRC of the data. If the new firmware image cannot be validated, it is ignored and the existing firmware image remains as the logical construct 26.

In step 114, the new firmware image replaces the existing firmware image. In this embodiment of the invention, this is accomplished by resetting the processors, allowing the new firmware image to be loaded as the logical construct 26.

An important aspect of this invention is that the only direct communication path 16 involved in the firmware update is the primary communication path 30. This allows the remaining direct communication paths 16 to remain available for other data transmission transactions. The direct communication path 16 can be changed during the course of transmitting data. This allows the management software application 20 to pick the least congested path to communicate with the master sub-system 28.

Those skilled in the art of making embedded systems may develop other embodiments of the present invention. For example, the process of update firmware images may be distributed through the redundant embedded processors utilizing a binary tree structure. Or, an embedded processor may serve as a dedicated master sub-system used solely as a distribution node for the firmware images. However, the terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

I claim:

1. A firmware-image update system, comprising:
a high-level management device including a high-level management software application for transmitting a firmware image over a primary communication path;
a first embedded processor adapted to receive said firmware image over said primary communication path, re-transmit said firmware image over a secondary communication path, and load said firmware image as a logical construct; and
a redundant embedded processor adapted to receive said firmware image over said secondary communication path and load said firmware image as said logical construct.

2. The firmware-image update system of claim 1, wherein the first embedded processor includes a download buffer for accumulating the firmware image prior to the first embedded processor loading the firmware image as a logical construct.

3. The firmware-image update system of claim 1, wherein the first embedded processor includes a non-volatile memory for holding the firmware image prior to the first embedded processor loading the firmware image as a logical construct.

4. The firmware-image update system of claim 2, wherein the first embedded processor further includes a non-volatile memory for holding the firmware image prior to the first embedded processor loading the firmware image as a logical construct.

5. The firmware-image update system of claim 1, wherein the first embedded processor includes a download buffer for accumulating the firmware image and a non-volatile memory for holding the firmware image prior to loading the firmware image as a logical construct.

6. A method of updating firmware images, comprising the steps of:
selecting a master sub-system including a first embedded processor;
preparing the master sub-system for a firmware image download;
preparing a redundant embedded processor for a firmware image download;
downloading a new firmware image from a high-level management device to the master sub-system;
re-distributing the new firmware image from the master sub-system to the redundant embedded processor; and
loading the new firmware image into the first embedded processor and the redundant embedded processor as a logical construct.

7. The method of claim 6, further comprising the step of accumulating the new firmware image in a download buffer prior to loading the new firmware image into the first embedded processor.

8. The method of claim 6, further comprising the step of holding the new firmware image in a non-volatile memory prior to loading the new firmware image into the first embedded processor.

9. The method of claim 7, further comprising the step of holding the new firmware image in a non-volatile memory prior to loading the new firmware image into the first embedded processor.

10. The method of claim 6, wherein the first embedded processor includes a download buffer for accumulating the new firmware image and a non-volatile memory for holding the new firmware image prior to loading the new firmware image into the first embedded processor.

11. An article of manufacture including a data storage medium, said data storage medium including a set of machine-readable instructions that are executable by a processing device to implement an algorithm, said algorithm comprising the steps of:
selecting a master sub-system including a first embedded processor;
preparing the master sub-system for a firmware image download;
preparing a redundant embedded processor for a firmware image download;
downloading a new firmware image from a high-level management device to the master sub-system;
re-distributing the new firmware image from the master sub-system to the redundant embedded processor; and
loading the new firmware image into the first embedded processor and the redundant embedded processor as a logical construct.

12. The article of manufacture of claim 11, further comprising the step of accumulating the new firmware image in a download buffer prior to loading the new firmware image into the first embedded processor.

13. The article of manufacture of claim 11, further comprising the step of holding the new firmware image in a non-volatile memory prior to loading the new firmware image into the first embedded processor.

14. The article of manufacture of claim 12, further comprising the step of holding the new firmware image in a non-volatile memory prior to loading the new firmware image into the first embedded processor.

15. The article of manufacture of claim 11, wherein the first embedded processor includes a download buffer for accumulating the new firmware image and a non-volatile memory for holding the new firmware image prior to loading the new firmware image into the first embedded processor.
